(19) United States
(12) Patent Application Publication
(10) Pub. No.: US 2025/0239103 A1
(43) Pub. Date: Jul. 24, 2025

(54) INTERACTIVE GOWNING AND GOWNING VERIFICATION

(71) Applicant: Merck Sharp & Dohme LLC, Rahway, NJ (US)

(72) Inventor: Nitin Kaul, Belle Mead, NJ (US)

(21) Appl. No.: 18/419,514

(22) Filed: Jan. 22, 2024

(51) Int. Cl. G06V 40/20; G06T 7/70; G06V 10/26; G06V 20/52

(52) U.S. Cl. CPC G06V 40/20; G06T 7/70; G06V 10/26; G06V 20/52; G06T 2207/30196

(57) ABSTRACT

A device includes a camera, a display and a computer-based analysis subsystem. The computer-based analysis subsystem is configured to perform operations including receiving images captured by the camera, the images including a first image depicting a subject performing an ongoing task, analyzing the first image by applying a machine-learned model to segment the images, isolate segments depicting the subject, and extract features from the segments, determining, based on the analyzing, that the subject's performance of the ongoing task is not in accordance with a compliance requirement of the ongoing task, and causing the display to display an indication of why the subject's performance of the ongoing task is not in accordance with the compliance requirement.

### BACKGROUND

### Technical Field

The subject matter described relates to providing interactive gowning and gowning verification.

### Background Information

There are various problems related to the safety and effectiveness of wearing protective gear in sterile and/or hazardous environments. Improper use or fit of protective gear can compromise its ability to maintain the sterility of the environment and/or protect the wearer from potential hazards or pathogens. Incomplete or incorrect execution of steps required to properly wear and use protective gear can also compromise its effectiveness in providing protection to both the environment and the wearer. Difficulty in monitoring and verifying compliance with specific requirements and guidelines for protective gear use may lead to time and resource intensive efforts to resterilize the environment as well as potential health and safety risks for the wearer and others in the environment. Lack of real-time feedback and guidance to the wearer may also lead to potential errors or non-compliance.

### SUMMARY

The above and other problems may be addressed by systems and methods for providing interactive gowning and gowning verification. In one aspect, the present disclosure relates to a device that includes a camera, a display and a computer-based analysis subsystem. The computer-based analysis subsystem is configured to perform operations including receiving images captured by the camera, the images including a first image depicting a subject performing an ongoing task, analyzing the first image by applying a machine-learned model to segment the images, isolate segments depicting the subject, and extract features from the segments, determining, based on the analyzing, that the subject's performance of the ongoing task is not in accordance with a compliance requirement of the ongoing task, and causing the display to display an indication of why the subject's performance of the ongoing task is not in accordance with the compliance requirement.

In some embodiments, analyzing the first image includes: identifying and locating body parts and protective gear worn by the subject; grouping the identified body parts and protective gear of the subject into segments that correspond to different body parts and protective gear; and estimating the positions, orientations, and relationships between different segments to create a representation of the subject's body and the protective gear in the image.

In some embodiments, determining that the subject's performance of the ongoing task is not in accordance with a compliance requirement includes: determining, based on data generated by the analyzing of the first image, whether the protective gear covers the body of the subject; and generating an indication of the subject's performance of the ongoing task.

In some embodiments, determining whether the protective gear covers the body of the subject includes verifying that the protective gear covers the face, torso, arms, and legs of the subject.

In some embodiments, determining whether the protective gear covers the body of the subject includes any one of: verifying that the subject is wearing a hairnet; verifying that the subject's beard is covered; verifying that the subject's shirt is tucked in; verifying that the subject is wearing gloves; and verifying that the subject is wearing boots.

In some embodiments, determining whether the protective gear covers the body of the subject includes: determining an optimal fit of the protective gear on the subject; and comparing the optimal fit to an actual fit to determine if the protective gear is properly worn by the subject.

In some embodiments, the device further includes a speaker and the operations further include causing the speaker to generate voice commands directing the subject through the ongoing task.

In some embodiments, the voice commands include instructions requiring the subject to perform a visual self-inspection to verify that the protective gear is worn properly.

In some embodiments, the indication that is displayed on the display indicates an explanation of how to fix a problem detected by the computer-based analysis subsystem or an instruction to start the process again if the problem is not fixable.

In some embodiments, the device further includes a microphone and the operations further include: receiving a recording, generated by the microphone, of an utterance made by the subject; analyzing the utterance to determine it includes a voice command; and implementing the voice command.

In one aspect, the present disclosure relates to a method that includes: receiving images including a first image depicting a subject performing an ongoing task; analyzing the first image by applying a machine-learned model to segment the image, isolate segments depicting the subject, and extract features from the segments; determining, based on the analyzing, that the subject's performance of the ongoing task is not in accordance with a compliance requirement of the ongoing task; and causing a display to display an indication of why the subject's performance of the ongoing task is not in accordance with the compliance requirement.

In one aspect, the present disclosure relates to a computer program product that includes a non-transitory computer readable storage medium having instructions encoded thereon that, when executed by a computing system, cause the computing system to perform operations including: receiving images including a first image depicting a subject performing an ongoing task; analyzing the first image by applying a machine-learned model to segment the image, isolate segments depicting the subject, and extract features from the segments; determining, based on the analyzing, that the subject's performance of the ongoing task is not in accordance with a compliance requirement of the ongoing task; and causing a display to display an indication of why the subject's performance of the ongoing task is not in accordance with the compliance requirement.

### BRIEF DESCRIPTION OF THE DRAWINGS

Figure (FIG. 1 illustrates a networked computing environment suitable for implementing an interactive gowning and gowning verification, according to one embodiment.

FIG. 2 illustrates an analysis subsystem of the computing server of FIG. 1, according to one embodiment.

FIG. 3 is a flowchart depicting an example process for providing interactive gowning and gowning verification, according to one embodiment.

FIGS. 4-7 illustrate indications of the performance of a subject performing tasks to properly wear protective gear, according to various embodiments.

FIG. 8 is a block diagram illustrating an example computer suitable for use in the networked computing environment of FIG. 1, according to one embodiment.

### DETAILED DESCRIPTION

The figures and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

### Example Systems

FIG. 1 illustrates one embodiment of a networked computing environment 100 suitable for implementing interactive gowning and gowning verification. In the embodiment shown, the networked computing environment includes a camera device 110, a client device 120, a computing server 130, all connected via a network 140. In other embodiments, the networked computing environment 100 includes different or additional elements. In addition, the functions may be distributed among the elements in a different manner than described. For example, although the camera device 110, the client device 120, the computing server 130 are shown as distinct entities, in some embodiments the corresponding functionality is provided by a single computing system (e.g., a client device).

The camera device 110 includes any device that is capable of capturing images or video, such as a digital camera, a smartphone camera, or a webcam. The camera device 110 uses a lens to focus light onto an image sensor, which captures the light and converts it into a digital signal that can be stored or transmitted. Some features of the camera device include a resolution, a sensor size, a focal length, zoom and autofocus features, an image stabilization feature, and a connectivity feature. The resolution of the camera device refer to the number of pixels that can be captured in an image or video. For example, higher resolution cameras capture more detailed and sharp images and videos. The size of the camera sensor can affect the quality of the resulting images and videos, with larger sensors generally providing better low light performance and depth of field. The focal length of a lens of the camera device determines the field of view and can affect the perspective and distortion of images and videos. Some camera devices have the ability to zoom in and out, either optically or digitally, to change the field of view. Autofocus systems in camera devices can help to maintain sharp focus on a subject as it moves or the distance changes. Image stabilization systems in camera devices can help to reduce blurring and shake in images and videos caused by movement or handshake. Some camera devices may have wireless connectivity options such as Wi-Fi or Bluetooth, allowing for easy transfer of images and videos to other devices.

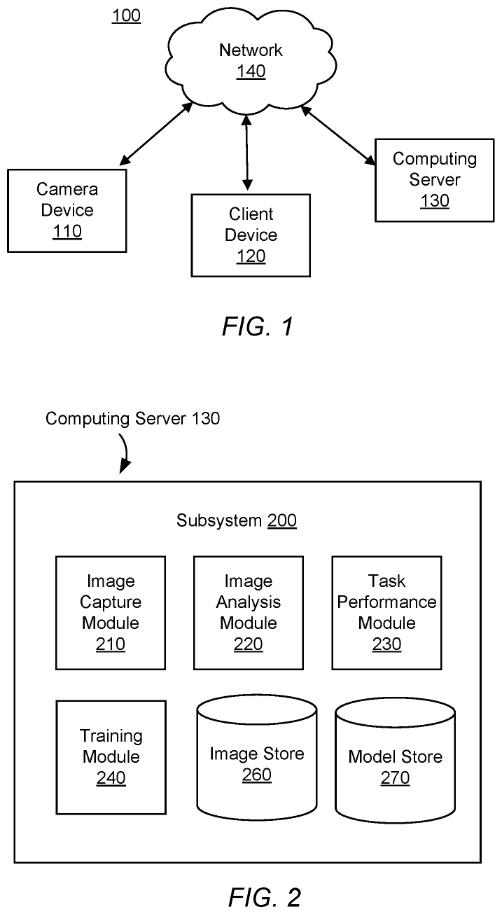

A computing server 130 hosts and runs the necessary software tools, machine learning algorithms, and data processing services to implement an interactive gowning and gowning verification process. The computing server 130 can include an analysis subsystem 200 as described in FIG. 2. The computing server 130 can include high-performance processors (CPUs), a large amount of memory (RAM), and dedicated graphics processing units (GPUs) for carrying out computer intensive tasks related to machine learning algorithms and image and video processing. The computing server 130 can run an operating system capable of managing the hardware resources and providing a platform for installing and running required software tools and libraries. Such software includes development environments, programming languages (e.g., Python, Java, C++) and machine learning libraries (e.g., TensorFlow, PyTorch) necessary for implementing and executing interactive gowning and gowning verification algorithms.

The computing server 130 can store and manage various pre-trained and ready-to-train machine learning models for implementing and executing interactive gowning and gowning verification. For example, these models can be tailored to process different resolutions and complexities of input data and handle specific types of clothing, garments and body poses in a given image or video. The computing server 130 can handle the storage and management of large datasets, including training images and videos annotated with ground truth poses, segmentations, and keypoints. For example, the computing server 130 can efficiently manage data for optimizing the training and inferencing processes in pose segmentation. The computing server 130 can connect to a network 140 that allows client devices 120 to send input images and videos for processing and receives the results of pose segmentation for implementing and executing interactive gowning and gowning verification.

The client device 120 is a computing device that communicates with the computing server 130 over the network 140. The client device 120 can be a local device to the gowning area. The client device 120 can include a graphical user interface (GUI) for displaying and providing interactive gowning instructions and gowning verification process to a user. For example, the client device 120 can include additional input/output devices, such as a speaker, a microphone, a keyboard, or a pointing device to interact with the user during the task. The speaker can be used to generate voice commands and/or feedback to the user. The microphone can be used to capture any audio input from the environment during the ongoing task. The keyboard and/or the pointing device can be used to input data and interact with the interactive gowning instructions and verification process provided by the computing server 130.

The network 140 provides the communication channels via which the other elements of the networked computing environment 100 communicate. The network 140 can include any combination of local area and wide area networks, using wired or wireless communication systems. In one embodiment, the network 140 uses standard communications technologies and protocols. For example, the network 140 can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 140 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 140 may be represented using any suitable format, such as hypertext markup language (HTML) or extensible markup language (XML). In some embodiments, some or all of the communication links of the network 140 may be encrypted using any suitable technique or techniques.

FIG. 2 illustrates one embodiment of an analysis subsystem 200 of the computing server 130 for implementing an interactive gowning and gowning verification. In the embodiment shown, the analysis subsystem 200 includes an image capture module 210, an image analysis module 220, a task performance module 230, a training module 240, an image store 260 and a model store 270. In other embodiments, the computing server 130 includes different or additional elements. In addition, the functions may be distributed among the elements in a different manner than described.

The image capture module 210 can be a software component that communicates with a camera to receive images captured by a camera. These images can depict a wide range of subjects and scenarios, including a subject performing an ongoing task. The image capture module 210 can store the image received from the camera in the image store 260. The functions of the image capture module include collecting image data, processing it if necessary, and transmitting it to other components or modules for further analysis and processing.

A “subject” refers to an individual being captured in the image or video frames. The subject can be a person or any entity that can be visually represented in an image or video. The subject's appearance and/or behavior are of interest in this context, and these characteristics can be extracted and analyzed using various image processing techniques. The subject's pose, orientation, movement, interaction with objects or other subjects, and other visual attributes can be the focus of the subsequent image processing and analysis. The subject's context and environment are also essential considerations in analyzing images and videos. These factors may include lighting conditions, background noise, camera settings, and other external factors that may affect the quality and usefulness of the captured data.

An “ongoing task” refers to a specific sequence of actions or movements that an individual performs to complete a task such as wearing protective gear, including a gown, hairnet, gloves, or boots. The task involves several individual steps that the subject takes in a particular order to wear the protective gear correctly. These steps may include putting on the garment or equipment, adjusting its size and fit, fastening any straps, zippers, or closures, ensuring that all exposed body areas are covered, and verifying that the protective gear is secure and comfortable to wear. The ongoing task's purpose is to ensure that the protective gear is being worn correctly and effectively, maintaining the sterility of the environment and reducing health and safety risks for the subject and others. The sequence of steps in the task must be executed systematically and accurately to achieve the desired outcome and minimize exposure of the environment to contaminants and/or the wearer to potential hazards.

Protective gear refers to any clothing or equipment worn by the subject to protect themselves from potential hazards or health risks in the environment or to protect the environment from potential contaminants that may be brought into the environment by the wearer. This can include items such as gowns, gloves, hairnets, boots, face masks, goggles, and respirator depending on the specific requirements of the task being performed.

The image analysis module 220 can analyze image and video data depicting an ongoing task of a subject to detect the individual steps and monitor the compliance of the subject with each step. For example, the image analysis module 220 can apply machine learning algorithms to the image and video data to identify the individual steps and verify that they have been executed correctly, providing feedback and guidance to the subject to ensure proper use of the protective gear.

For example, the image analysis module 220 can analyze an image by applying a machine-learned model to segment the image by isolating and identifying specific regions or segments within the image that depict the subject performing the ongoing task. The machine-learned model can be trained to recognize and extract regions in the image based on specific visual features and patterns. The visual features and patterns may include: contour, shape, color, texture, object relationships, pose and gestures. For example, the model may learn to recognize the contours and shapes of gowns and identify regions within the image that contain such contours and shapes. The model can also learn to recognize the colors and textures of gowns and identify regions within the image that contain such colors and textures. The model can further learn to recognize specific object relationships, such as detecting that a gown is being put on a body part or that straps are being fastened in a certain way. The model may learn to recognize specific body poses and gestures that are indicative of the subject performing the ongoing task.

In one embodiment, the image analysis module 220 analyzes the first image by applying a machine-learned model to segment the images, isolate segments depicting the subject, and extract features from the segments.

### Segmentation of an Image

In one embodiment, the segmentation of the image can include object recognition, pose estimation, and analysis of ongoing tasks. By segmenting the image, the image analysis module 220 can identify and monitor the subject and movement patterns, specifically related to wearing protective gear correctly. For example, the machine learning model for image segmentation can be trained on a large set of annotated images, where the regions of interest and their associated visual features are labeled manually. Once the model is trained, it can be applied to new images or videos to segment the regions of interest automatically. Once the subject's regions of interest are identified and segmented, the image analysis module 220 can extract visual features related to the ongoing task's execution by the subject. These features may include specific poses, gestures, movements, or interactions with objects or tools. The extracted features can then be used to monitor the subject's compliance with each step of the task.

### Isolation of Segments

After segmenting the image, the analysis module 220 can isolate segments depicting the subject involves selecting and extracting only the image regions that depict the subject's body parts or features. The machine-learned model applied for isolating segments depicting the subject is trained to recognize and extract specific features related to the subject's body parts and appearance. These models can be trained on a large dataset of annotated images where the regions of interest are labeled to contain the subject's body. Once the machine-learned model has isolated the subject's body from the image, the image analysis module 220 can focus only on the subject's body parts and movements, ignoring any potential background or noise in the image. This step can analyze specific movements and actions of the subject to ensure safely and safely use the protective gear. Irrelevant areas of the image can be ignored to reduce noise and errors, resulting in more accurate and meaningful insights into the subject's performance. Once the machine-learned model has isolated the subject's body from the image, the image analysis module 220 can focus only on the subject's body parts and movements, ignoring any potential background or noise in the image.

Extraction of Features from the Segments

The image analysis module 220 can identify and extract specific visual features and patterns from the image segments isolated by the previous steps. The machine-learned model applied for feature extraction is trained to recognize and extract specific features related to the subject's body parts, poses, and movements while wearing protective gear. By extracting these features from the image segments, the image analysis module can identify relevant behaviors and movements in the context of the ongoing task, such as correct pose, accurate placement of protective gear, or timely execution of specific steps. For example, the image analysis module can analyze and monitor the subject's performance in real-time and provide feedback or guidance when necessary.

The task performance module 230 can determine non-compliance with the compliance requirement of the ongoing task by analyzing the previously segmented, isolated and feature extracted image data and comparing it to the expected compliance requirements. For example, the task performance module 230 can determine whether the protective gear covers the body of the subject by verifying that it covers the face, torso, arms, and legs. The module may use machine learning models to determine an optimal fit of the protective gear on the subject, comparing it to the actual fit to verify if the protective gear is properly worn.

The task performance module 230 can cause the display to display an indication of why the subject's performance of the ongoing task is not in accordance with the compliance requirement. For example, if the task performance module 230 detects that non-compliance exists, it can generate visual feedback that is displayed to the subject, such as highlighting the area of noncompliance within an image provided to an interface of a client device and providing guidance on how to correct the issue. The visual feedback could be generated in real-time to ensure instant feedback and provide a better learning environment for the subject to improve compliance.

Additionally, other specific compliance requirements could be determined, for example, verifying that the subject is wearing a hairnet, or that the subject's beard is covered, and comparing the actual image data to the expected standard. The image analysis module can use machine learning models to compare actual image data to the expected standards and alert immediately if there is non-compliance. The ability to identify and track compliance requirements while the task is being performed allows for quicker intervention and correction. The analytics can be reviewed over an extended period where tasks are being recorded, thereby improving ongoing quality control.

The training module 240 can train machine learning models used in analyzing image and video data. The training module 240 can preparing and manage large datasets. For example, the training module 240 handles the storage and management of large datasets, including training images and videos annotated with ground truth poses, segmentations, and keypoints. These training datasets can be used to train machine learning models that can perform specific image processing tasks, such as segmenting the image to identify and extract regions of interest.

The training module 240 can also train and optimize machine learning models. For example, the training module 240 can run training sequences through the models, monitoring the performance of the models and adjusting parameters to improve performance. The training module can further update and improve the machine learning models by processing additional data and adjusting the models' parameters. These updates can help improve the models' accuracy, efficiency and robustness.

The image store 260 can be a storage system or component responsible for storing and managing the images captured by the camera device. The primary purpose of the image store is to ensure that images are safely retained, organized, and easily accessible by other processing modules or software components when needed.

The model store 270 is a storage system for storing and managing various pre-trained and ready-to-train machine learning models used for implementing and executing interactive gowning and gowning verification. In this context, the pre-trained models are tailored to process different resolutions and complexities of input data and handle specific types of clothing, garments, and body poses in a given image or video. This allows for efficient access to specific models that are best suited to handle a particular task or type of data. The model store also handles the management of the trained models and their associated parameters and coefficients, which are used to process new data and improve the model's accuracy and performance.

The computer server can provide significant advantages. By verifying that protective gear is worn correctly and effectively, the computer server can help reduce the risk of contamination of the environment and/or potential health and safety risks for the wearer and others in the environment. The computer server can provide real-time feedback and guidance to the wearer during the task, reducing the risk of errors or non-compliance during the task. The use of machine learning algorithms and image processing techniques enables the computer server to analyze large amounts of data quickly and accurately, improving the efficiency of protective gear monitoring and verification. The computer server can continuously monitor and analyze performance data to detect any issues with protective gear use, allowing for prompt intervention and correction. Furthermore, the computer server can be used with a variety of devices and setups, making it accessible to a wide range of users and environments.

### Example Methods

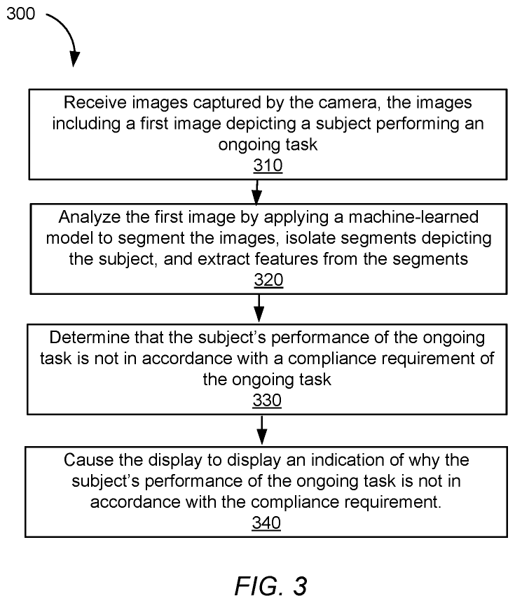

FIG. 3 is a flowchart depicting an example process 300 for providing interactive gowning and gowning verification, in accordance with some embodiments. Various steps in the process 300 may be processes that are performed by the image analysis module 220 and the task performance module 230, or other modules in the subsystem 200. Various processes may be implemented as one or more software algorithms. The software algorithm may be stored as computer instructions that are executable by one or more general processors (e.g., CPUs, GPUs). The instructions, when executed by the processors, cause the processors to perform various steps described. In various embodiments, one or more steps described may be skipped or changed. Steps described in FIG. 3 may also be combined with those in other figures. The computer-implemented process 300 may be performed by the computing server 130, although the process may also be performed by another suitable computer.

At 310, the computing server receives images captured by a camera, the images including a first image depicting a subject performing an ongoing task.

At 320, the computing server analyzes the first image by applying a machine-learned model to segment the images, isolate segments depicting the subject, and extract features from the segments. For example, the analysis of the image can include identifying and locating body parts and protective gear worn by the subject. This can be performed using various computer vision techniques, such as semantic segmentation and instance segmentation. The analysis of the image can further include grouping the identified body parts and protective gear of the subject into segments that correspond to different body parts and protective gear, and estimating the positions, orientations, and relationships between these different segments to create a “skeleton-like” representation of the subject's body and the protective gear in the image.

At 330, the computing server determines that the subject's performance of the ongoing task is not in accordance with a compliance requirement of the ongoing task. For example, the computing server can determine whether the protective gear covers the body of the subject. For example, the computing server can verify that the protective gear covers the face, torso, arms, and legs of the subject. The computing server can further verify that the subject is wearing a hairnet, the subject's beard is covered, the subject's shirt is tucked in, the subject is wearing gloves, and/or the subject is wearing boots.

In some embodiments, the computing server determines with a machine-learned model an optimal fit of the protective gear on the subject and compares the optimal fit to an actual fit to determine if the protective gear is properly worn by the subject.

At 340, the computing server causes the display to display an indication of why the subject's performance of the ongoing task is not in accordance with the compliance requirement. For example, the computing server can further generate feedback for display if it is determined that the protective gear does not cover the body of the subject.

In some embodiments, the computing server causes speaker of a client device to generate voice commands directing the subject through the ongoing task. For example, the voice commands include instructions requiring the subject to perform a visual self-inspection to verify that the protective gear is worn properly.

In some embodiments, the indication that is displayed on the display indicates an explanation of how to fix a problem detected with the subject's performance of the ongoing task or an instruction to start the process again if the problem is not fixable.

In some embodiments, the computing server can receive a recording, generated by the microphone of the client, of an utterance made by the subject. The computing server can analyze the utterance to determine if it includes a voice command. The computing server can implement the voice command.

### Examples of Protective Gear Compliance Check

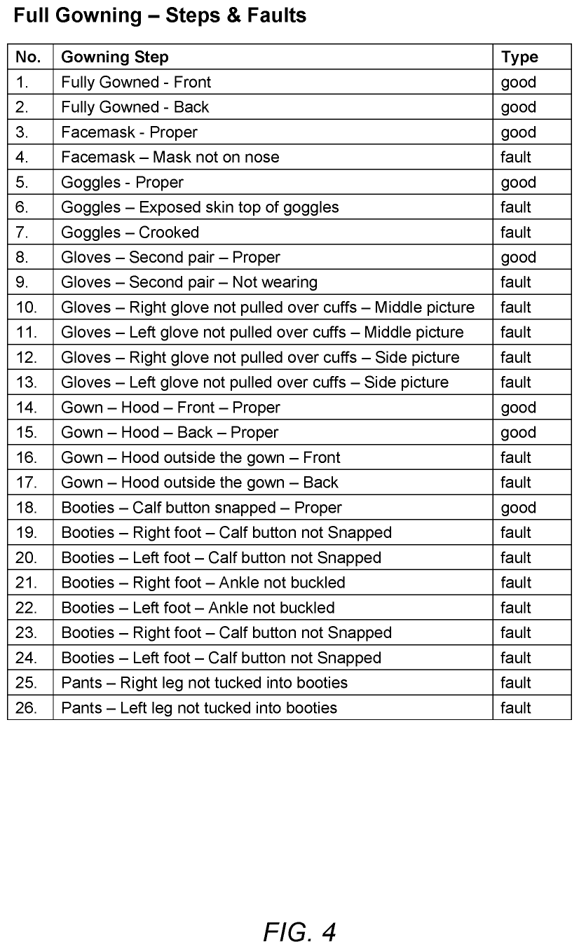

FIG. 4 illustrate an example a table generated by the computing server. The table represents an indication of the performance of a subject performing tasks to properly wear protective gear. FIG. 4 shows each step that is performed and whether the step is satisfactory (i.e., good) or faulty (i.e., fault).

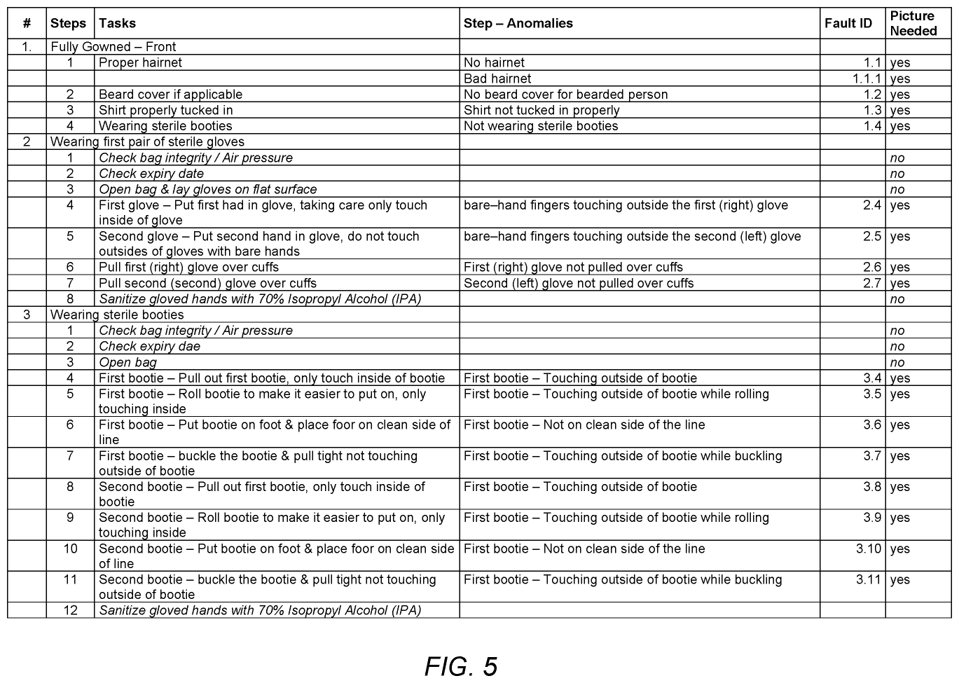

FIG. 5 illustrate another example a table generated by the computing server. The table is an indication of the performance of a subject performing tasks to properly wear protective gear. FIG. 5 shows each step that is performed, the anomalies in the performance of the corresponding step, a fault I.D, whether image verification is needed to validate the corresponding step.

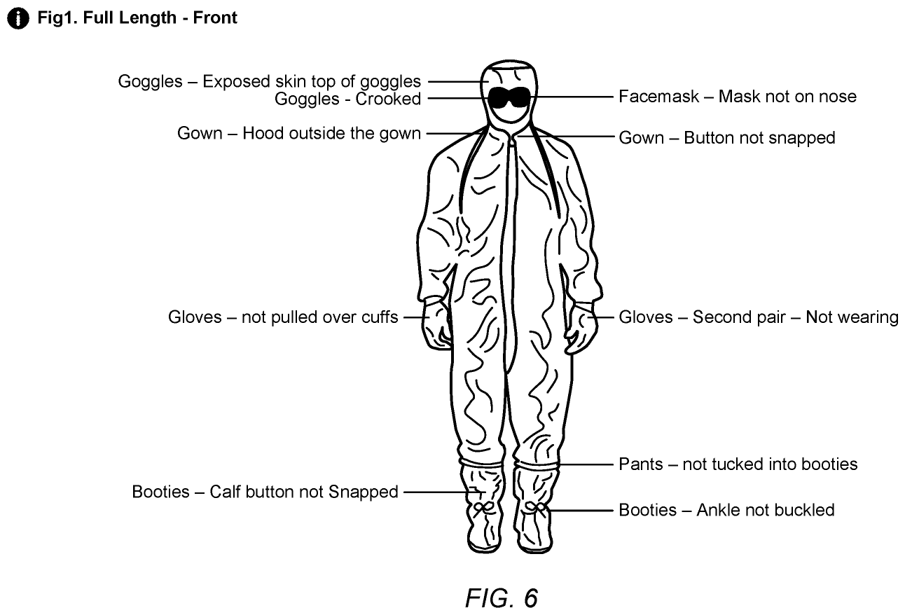

FIG. 6 illustrate an example of a visual feedback generated by the computer server. The visual feedback represents an indication of the performance of a subject performing tasks to properly wear protective gear. The visual feedback highlights areas of noncompliance within an image. The visual feedback can provide guidance on how to correct the issues. The visual feedback can be generated in real-time to ensure instant feedback and provide a better learning environment for the subject to improve compliance.

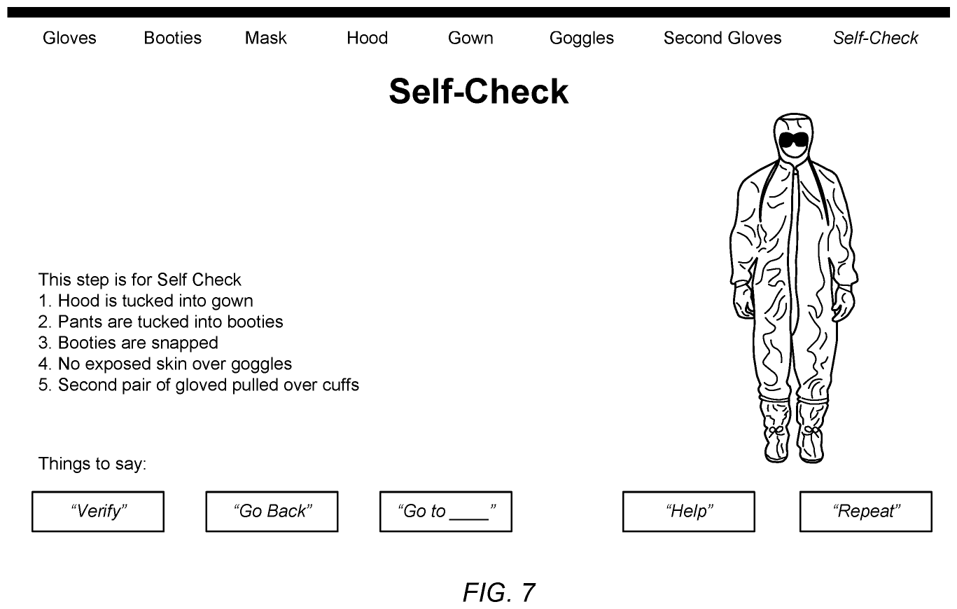

FIG. 7 illustrate another example of a visual feedback generated by the computer server. The visual feedback includes instructions requiring the subject to perform a visual self-inspection to verify that the protective gear is worn properly.

### Computing System Architecture

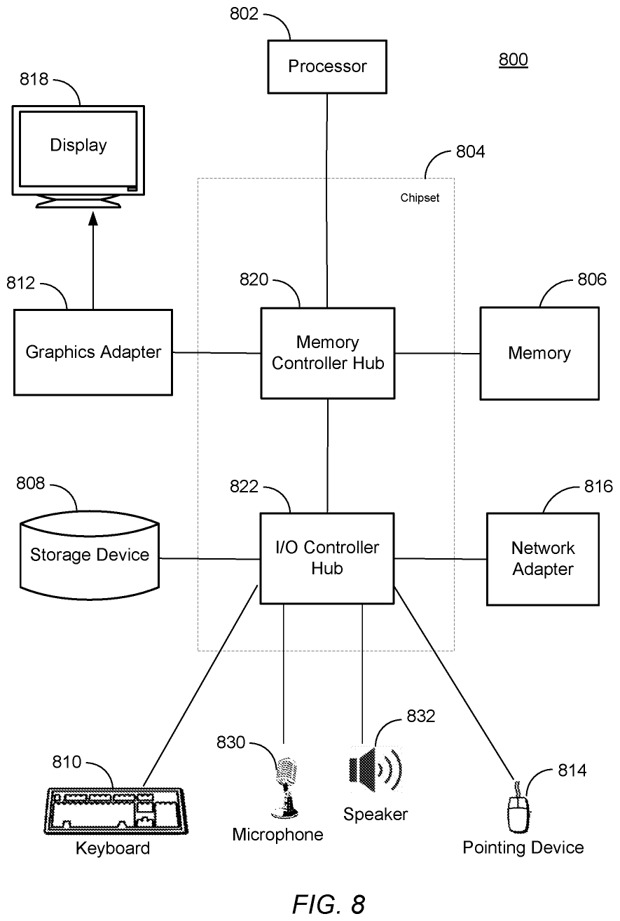

FIG. 8 is a block diagram of an example computer 800 suitable for use as a client device 120 or computing server 130. The example computer 800 includes at least one processor 802 coupled to a chipset 804. The chipset 804 includes a memory controller hub 820 and an input/output (I/O) controller hub 822. A memory 806 and a graphics adapter 812 are coupled to the memory controller hub 820, and a display 818 is coupled to the graphics adapter 812. A storage device 808, keyboard 810, pointing device 814, and network adapter 816 are coupled to the I/O controller hub 822. Other embodiments of the computer 800 have different architectures.

In the embodiment shown in FIG. 8, the storage device 808 is a non-transitory computer-readable storage medium such as a hard drive, compact disk read-only memory (CD-ROM), DVD, or a solid-state memory device. The memory 806 holds instructions and data used by the processor 802. The pointing device 814 is a mouse, track ball, touchscreen, or other type of pointing device, and may be used in combination with the keyboard 810 (which may be an on-screen keyboard) to input data into the computer system 800. The graphics adapter 812 displays images and other information on the display 818.

The microphone 830 is connected to the input/output (I/O) controller hub 822. The microphone may be an external device connected through a port or an internal device built into the computer. The microphone can capture audio input from the environment during a task performed by the subject and convert it into an electrical signal that can be processed by the computer. The speaker 832 is connected to the input/output (I/O) controller hub 822. The speaker can generate sound based on an electrical signal received from a computer or electronic device. The speaker can provide voice commands or feedback to the subject during an ongoing task by generating audible instructions or other audio output. The network adapter 816 couples the computer system 500 to one or more computer networks, such as network 140.

The types of computers used by the entities of FIGS. 1 and 2 can vary depending upon the embodiment and the processing power required by the entity. Furthermore, computers 500 can lack some of the components described above, such as keyboards 510, graphics adapters 512, and displays 518.

### ADDITIONAL CONSIDERATIONS

Some portions of the above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing transactional access to resource repositories. Thus, while particular embodiments and applications have been illustrated and described, it is to be understood that the described subject matter is not limited to the precise construction and components disclosed. The scope of protection should be limited only by any claims that issue.

What is claimed is:

1. A device comprising:
a camera;
a display; and
a computer-based analysis subsystem configured to perform operations including:
receiving images captured by the camera, the images including a first image depicting a subject performing an ongoing task;
analyzing the first image by applying a machine-learned model to segment the image, isolate segments depicting the subject, and extract features from the segments;
determining, based on the analyzing, that the subject's performance of the ongoing task is not in accordance with a compliance requirement of the ongoing task; and
causing the display to display an indication of why the subject's performance of the ongoing task is not in accordance with the compliance requirement.

2. The device of claim 1, wherein analyzing the first image comprises:
identifying and locating body parts and protective gear worn by the subject;
grouping the identified body parts and protective gear of the subject into segments that correspond to different body parts and protective gear, and
estimating the positions, orientations, and relationships between different segments to create a representation of the subject's body and the protective gear in the image.

3. The device of claim 2, wherein determining that the subject's performance of the ongoing task is not in accordance with a compliance requirement comprises
determining, based on data generated by the analyzing of the first image, whether the protective gear covers the body of the subject; and
generating an indication of the subject's performance of the ongoing task.

4. The device of claim 3, wherein determining whether the protective gear covers the body of the subject comprises verifying that the protective gear covers the face, torso, arms, and legs of the subject.

5. The device of claim 3, wherein determining whether the protective gear covers the body of the subject comprises any one of:
verifying that the subject is wearing a hairnet;
verifying that the subject's beard is covered;
verifying that the subject's shirt is tucked in;
verifying that the subject is wearing gloves; and
verifying that the subject is wearing boots.

6. The device of claim 3, wherein determining whether the protective gear covers the body of the subject comprises:
determining an optimal fit of the protective gear on the subject; and
comparing the optimal fit to an actual fit to determine if the protective gear is properly worn by the subject.

7. The device of claim 1, wherein the device further includes a speaker and the operations further comprise:
causing the speaker to generate voice commands directing the subject through the ongoing task.

8. The device of claim 7, wherein the voice commands comprise instructions requiring the subject to perform a visual self-inspection to verify that the protective gear is worn properly.

9. The device of claim 1, wherein the indication that is displayed on the display indicates an explanation of how to fix a problem detected by the computer-based analysis subsystem or an instruction to start the process again if the problem is not fixable.

10. The device of claim 1, wherein the device further comprises a microphone and the operations further comprise:
receiving a recording, generated by the microphone, of an utterance made by the subject;
analyzing the utterance to determine it includes a voice command; and
implementing the voice command.

11. A method comprising:
receiving images including a first image depicting a subject performing an ongoing task;
analyzing the first image by applying a machine-learned model to segment the image, isolate segments depicting the subject, and extract features from the segments;
determining, based on the analyzing, that the subject's performance of the ongoing task is not in accordance with a compliance requirement of the ongoing task; and
causing a display to display an indication of why the subject's performance of the ongoing task is not in accordance with the compliance requirement.

12. The method of claim 11, wherein analyzing the first image comprises:
identifying and locating body parts and protective gear worn by the subject;
grouping the identified body parts and protective gear of the subject into segments that correspond to different body parts and protective gear, and
estimating the positions, orientations, and relationships between different segments to create a representation of the subject's body and the protective gear in the image.

13. The method of claim 12, wherein determining that the subject's performance of the ongoing task is not in accordance with a compliance requirement comprises
determining, based on data generated by the analyzing of the first image, whether the protective gear covers the body of the subject; and
generating an indication of the subject's performance of the ongoing task.

14. The method of claim 13, wherein determining whether the protective gear covers the body of the subject comprises verifying that the protective gear covers the face, torso, arms, and legs of the subject.

15. The method of claim 13, wherein determining whether the protective gear covers the body of the subject comprises any one of:
verifying that the subject is wearing a hairnet;
verifying that the subject's beard is covered;
verifying that the subject's shirt is tucked in;
verifying that the subject is wearing gloves; and
verifying that the subject is wearing boots.

16. The method of claim 11, wherein determining whether the protective gear covers the body of the subject comprises:
determining an optimal fit of the protective gear on the subject; and
comparing the optimal fit to an actual fit to determine if the protective gear is properly worn by the subject.

17. The method of claim 11, further comprising causing a speaker to generate voice commands directing the subject through the ongoing task.

18. The method of claim 17, wherein the voice commands comprise instructions requiring the subject to perform a visual self-inspection to verify that the protective gear is worn properly.

19. The method of claim 11, further comprising:
receiving a recording, generated by a microphone, of an utterance made by the subject;
analyzing the utterance to determine it includes a voice command; and
implementing the voice command.

20. A computer program product comprising a non-transitory computer readable storage medium having instructions encoded thereon that, when executed by a computing system, cause the computing system to perform operations including:
receiving images including a first image depicting a subject performing an ongoing task;
analyzing the first image by applying a machine-learned model to segment the image, isolate segments depicting the subject, and extract features from the segments;
determining, based on the analyzing, that the subject's performance of the ongoing task is not in accordance with a compliance requirement of the ongoing task; and
causing a display to display an indication of why the subject's performance of the ongoing task is not in accordance with the compliance requirement.
